(19) United States
(12) Patent Application Publication
(10) Pub. No.: US 2008/0220825 A1
(43) Pub. Date: Sep. 11, 2008

(54) Bluetooth earphone with multiple audio gateways

(75) Inventor: Wei Chien Wu, Taipei (TW)

Correspondence Address: BACON & THOMAS, PLLC, 625 SLATERS LANE, FOURTH FLOOR, ALEXANDRIA, VA, 22314-1176, US

(73) Assignee: Unigrand Ltd., Taipei County (TW)

(21) Appl. No.: 11/713,653

(22) Filed: Mar. 5, 2007

(51) Int. Cl. H04M 1/00

(52) U.S. Cl. 455/569.1

(57) ABSTRACT

A multiple audio gateway Bluetooth earphone, comprising an audio signal input module, an audio signal output module, a Bluetooth module, a key-in module; and a power supply. When the Bluetooth earphone is communicating via Bluetooth wireless connection with one of the audio gateways, another audio gateway may, via the existing or a newly established wireless connection, prompt another incoming call, and through the switching function built in the Bluetooth module, the earphone can detect the calling signals, and then trigger a signal to alert the user. The user may then choose to answer or ignore it, with the on-going call being hung up or put in waiting, or to invite the new caller to join as a multi-party phone conference.

### BACKGROUND OF THE INVENTION

1. Field of the Invention

The present invention relates to a Bluetooth module application, particularly one with multiple audio gateways that allow the user to switch between them freely.

2. Description of the Prior Art

With the rapid development of broadband infrastructure, more and more people are enjoying the benefits of wireless communication, including such conveniences as offered by wireless internet, the PDA, and the cell phone.

The transmission of earlier cell phones was through the use of infrared light. By connecting the IR ports of one device with that of another, signals was transmitted. The major drawback of infrared transmission is that the two IR ports must be aligned to function properly. (Imagine two notebook computers transmitting data through their IR ports.) The advantage of Bluetooth technology is that it allows two devices not in alignment to transmit data to each other through a certain wireless mode. As a matter of fact, as Bluetooth is a wireless technology, the transmission of wireless data can even ignore the existence of walls, pockets, cases, or bags etc., Moreover, Bluetooth transmission is much faster than that of the infrared. It is a cable replacement technology that allows any such device to be serially connected with any telecommunication, internet, and consumer electronic devices. The outlook of a Bluetooth device resembles a mini wireless transceiver. It is composed mainly of a wireless module and a Baseband Module, and can be designed into various products including notebook computers, cell phones, and other hand-held devices. Bluetooth transmission is 2.4 GHz high frequency transmission, a universal spectrum free of interruption. Furthermore, transmitters incorporating the Bluetooth technology can communicate with WAN or the Internet via digital or vocal data, and all end products using the technology can also communicate with each other in the same mode.

For this reason, Bluetooth earphones are now sold as standard accessories of many cell phones, and almost all cell phones have made Bluetooth their standard functions, making the application and function of Bluetooth technology ever more varied and versatile. However, current Bluetooth earphones function only one-on-one, i.e, one cell phone can only use one Bluetooth earphone at a time—a user cannot, during a cell phone conversation, switch the earphone to another cell phone or voice data source, leaving an important feature still to be desired of the Bluetooth technology.

### BRIEF DESCRIPTION OF THE INVENTION

In view of the above imperfection, the inventor has, after years of research and development effort, come up with the present invention of Multiple Audio Gateway Bluetooth Earphone. The new device comprises: an audio signal input module—generally a microphone—to send out signals at the device's receiving end; an audio signal output module, to send out the user's audio signals; a Bluetooth module, to transmit or receive Bluetooth signals, with the Bluetooth module having built-in micro processor or DSP (Digital Signal Processor) to process incoming and outgoing audio signals and to switch between various Audio Gateways or integrate the signals; a key-in module with buttons for users to press commands; and a power supply, to provide required power.

With the above structure, the audio gateways can be the source end of any available Bluetooth earphone, which may be a computer, a cell phone, or a PDA. When the Bluetooth earphone is in waiting mode, any incoming calls through any one of the cell phones, I-phones, or PDAs, can be received through the earphone. When the Bluetooth earphone is communicating with one of the cell phones, any incoming calls through any one of the cell phones, I-phones, or PDAs will trigger a signal alerting the user that there is another call, and the user may choose to receive or ignore the new call, with the on-going call being hung up or put in waiting, or invite the new caller to join the on-going conversation to form a multi-party phone conference.

To let the examiners further understand the technical features of the present invention, the inventor will further describe the present invention in the following with illustrations. However, it is to be understood that the illustrations may serve only to highlight, rather than to limit, the scope of the present invention.

### DESCRIPTION OF THE PREFERRED EMBODIMENT

Please refer to FIG. 1. FIG. 1 shows the circuitry diagram of the present invention's Multiple Audio Gateway Bluetooth earphone. The device comprises: an audio signal input module 10, the function of which is to receive audio signals; an audio signal output module 20, the function of which is to output the user's audio signals; a Bluetooth module 30, the function of which is to transmit or receive Bluetooth signals and to switch between various Audio Gateways or integrate the signals; a key-in module 40 with buttons on it for users to press commands; a power supply 60 to provide required power; and an antennae 50 to serve as the transceiving end of wireless signals.

Please refer to FIG. 2. FIG. 2 illustrates how the present invention's Multiple Audio Gateway Bluetooth earphone works in actual application. When the Bluetooth earphone 120 is in waiting mode, any incoming calls through any cell phone (audio gateway A), I-phone (audio gateway B), can be received through the earphone For example, when there is a call coming in through a cell phone (audio gateway A), the user 110 can answer the call through the Bluetooth earphone 120, establishing a communication process 150 (on-going conversation 1) thereby. When, at the same time, there is another call coming in through an I-phone (audio gateway B), the Bluetooth earphone 120 can detect it and trigger a signal to alert the user 110 that there is another call coming in through audio gateway B. Audio Gateway 2 will then notice the user 160 via Bluetooth wireless connection that new audio signals are coming in, and the user 160 can choose to hang up the on-going conversation in audio gateway A and establish conversation 170 with the caller at audio gateway B, or hold on the conversation at audio gateway A, and establish conversation 170 with the caller on audio gateway B (conversation in waiting 1; conversation started 2). The user 160 can also choose to ignore the call or combine audio gateway A, B, and other gateways, to form a multi-party phone conference. The same operation mode applies to other gateways, if available.

Please refer to FIG. 3 composed by FIG. 3A-H illustrates the circuitry diagram of the present invention's multiple audio gateway earphone. The current embodiment uses CSR (Cambridge Silicon Radio) BC04-Audio chip as main chip, relevant information of which is given below.

1. Power

a. External battery, like Li-ion, from BAT1 to VDD_BAT and output to V1.8.

b. The main chip has switching regulator inside, then produce V1.8 for internal usage.

c. Microphone bias voltage is supplied by U6. The main chip uses MIC_ENABLE to control U6 to power on or off.

The purpose of using U6 is to enhance audio quality by minimize the bias noise.

2. RF

U3 is RF combo filter with uni-direcitonal output. The RF band of U3 is 2.4 GHz for Bluetooth.

3. UI (User Interface)

a. SW1 (on/off), SW2 (VOL+), and SW3 (VOL−) are input buttons.

b. D2 (Blue LED) and D3 (Red LED) are output indications.

To power on the headset, press SW1 long and wait the Red LED to start to flash.

On two SCO's situation, SW1 also has special function, like switching different SCO's to talk.

4. Charger

This example headset uses internal charger to charge the battery, and the power input is U4 (USB 5V).

As is understood by a person skilled in the art, the foregoing preferred embodiment of the present invention is an illustration, rather than a limiting description, of the present invention. It is intended to cover various modifications and similar arrangements included within the spirit and scope of the appended claims (for example, the number of audio gateways and input units shall never affect the scope and spirit of the present invention), and the scope of which should be accorded the broadest interpretation so as to encompass all such modifications and similar structures.

### BRIEF DESCRIPTION OF THE DRAWINGS

FIG. 1 shows how the circuitry diagram of the present invention's multiple audio gateway Bluetooth earphone.

FIG. 2 shows the functioning process of the present invention's multiple audio gateway Bluetooth earphone.

FIG. 3A-H are parts of the circuitry of the present invention's multiple audio gateway Bluetooth earphone.

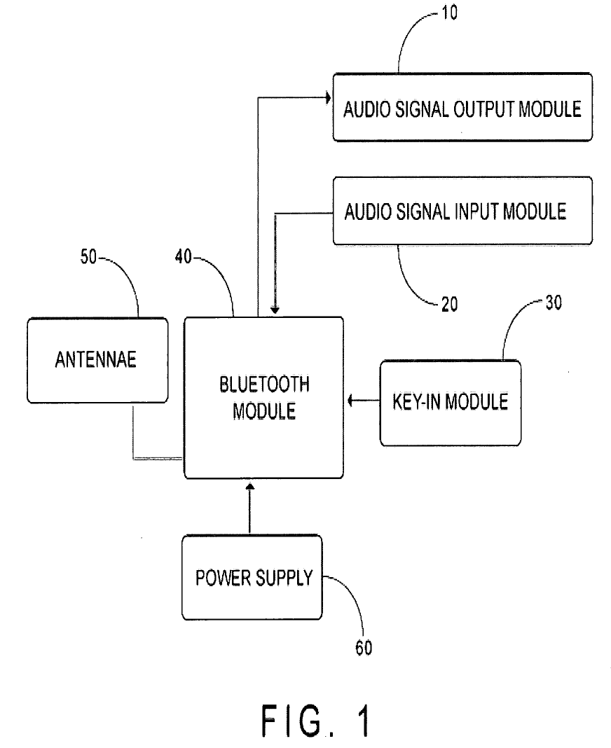

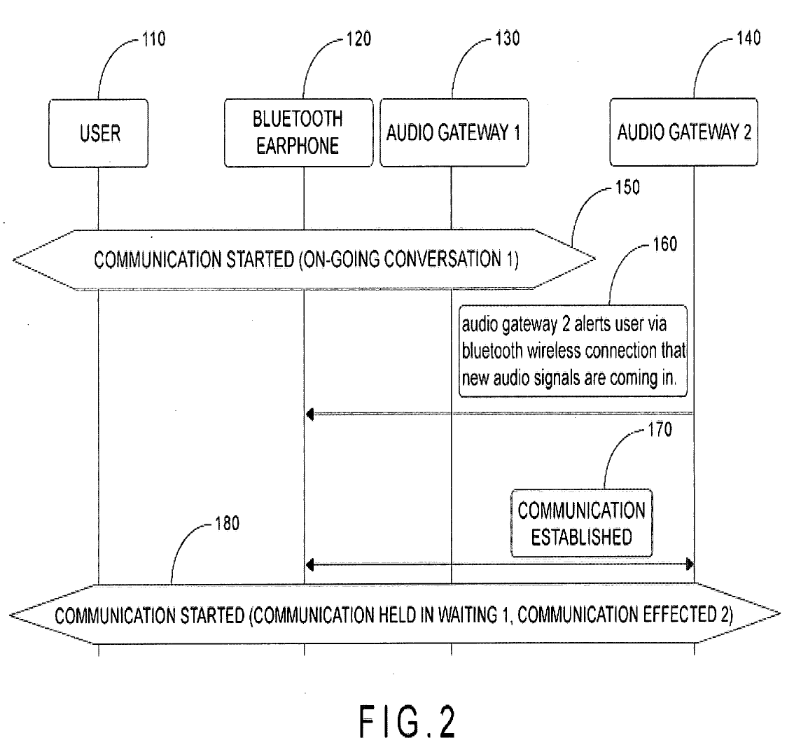

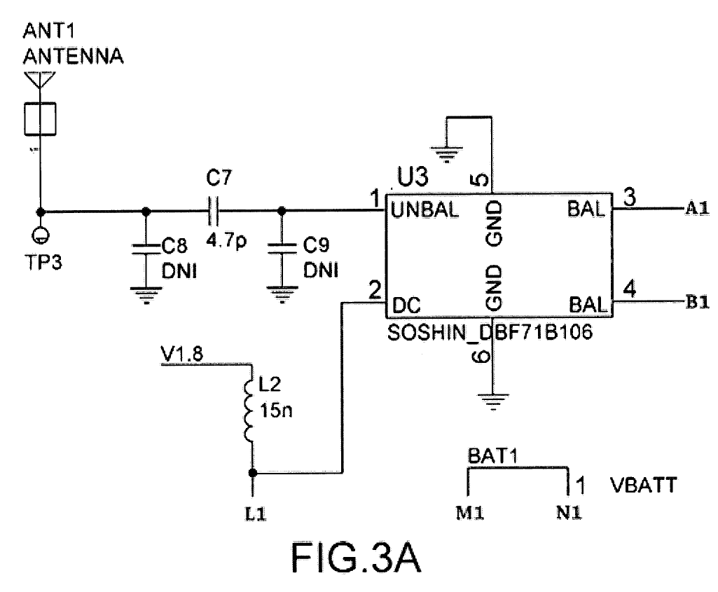

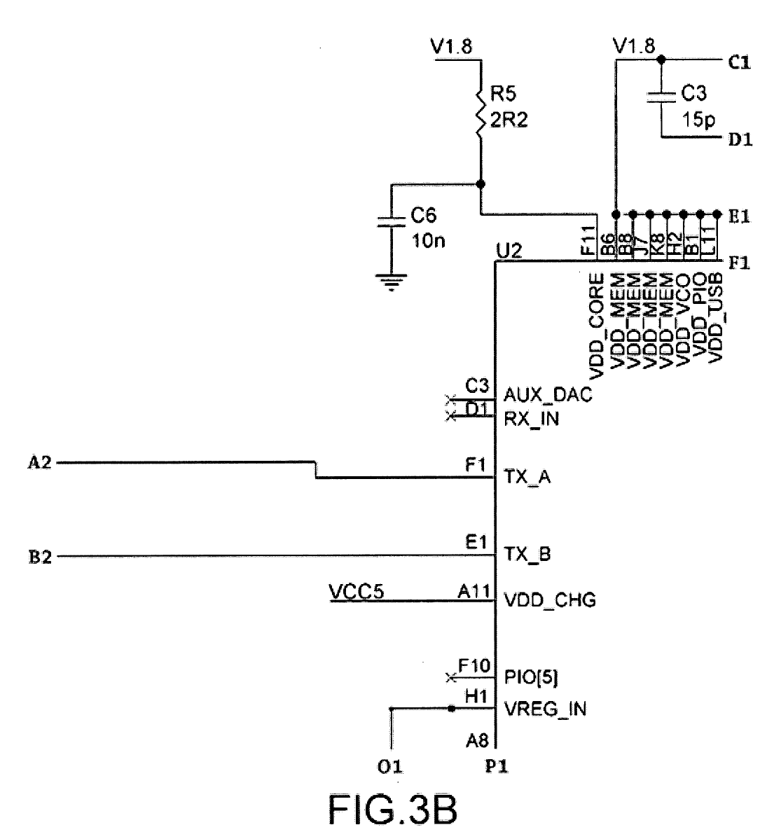

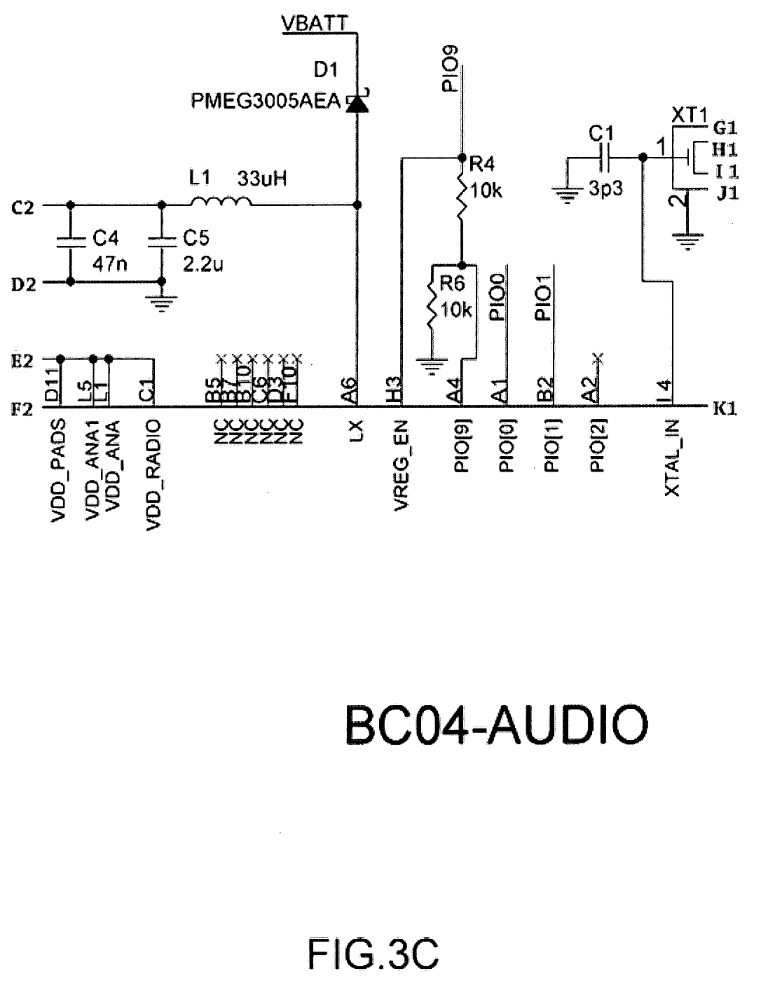

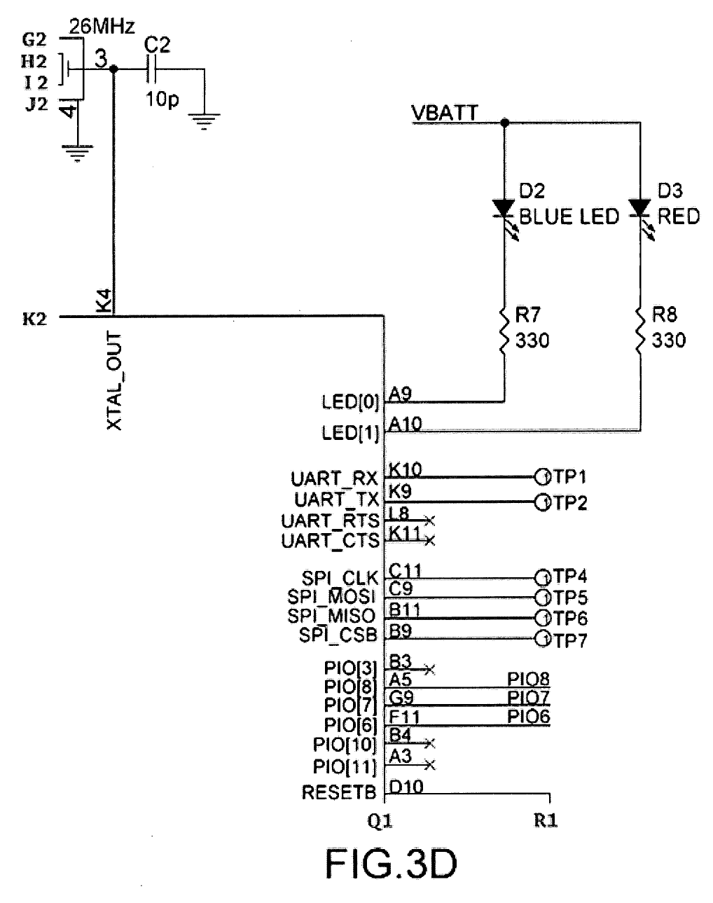

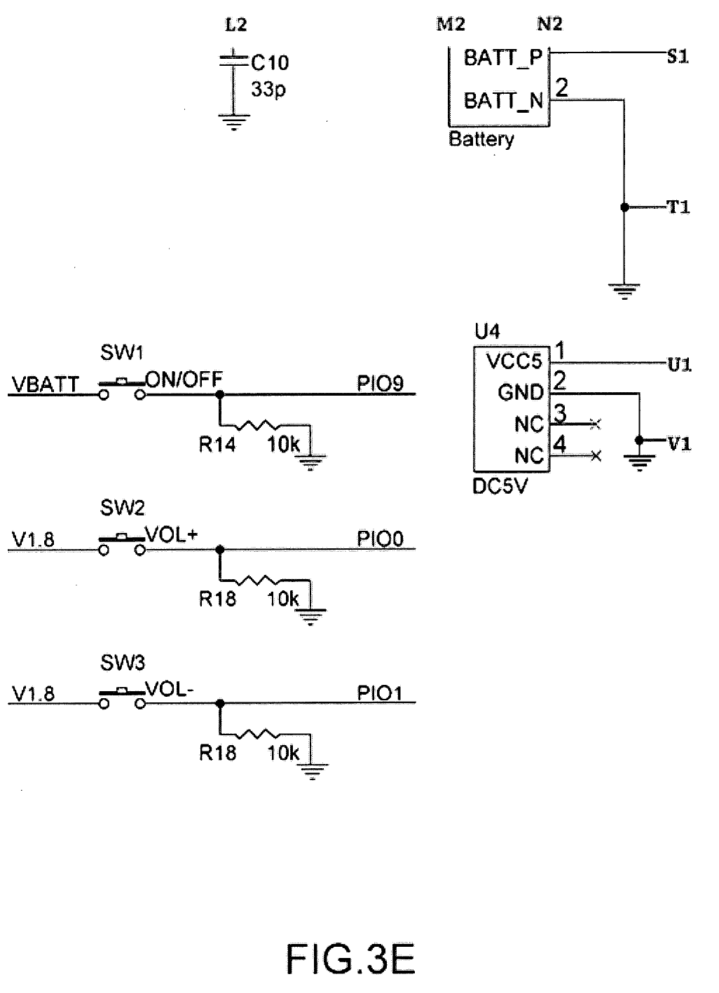

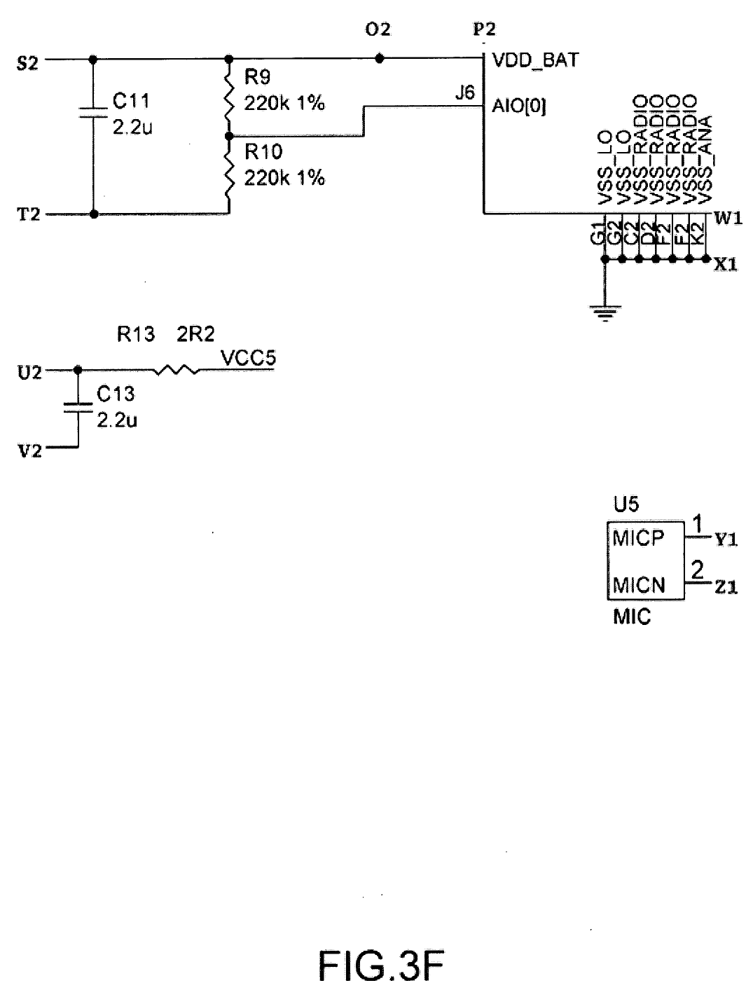

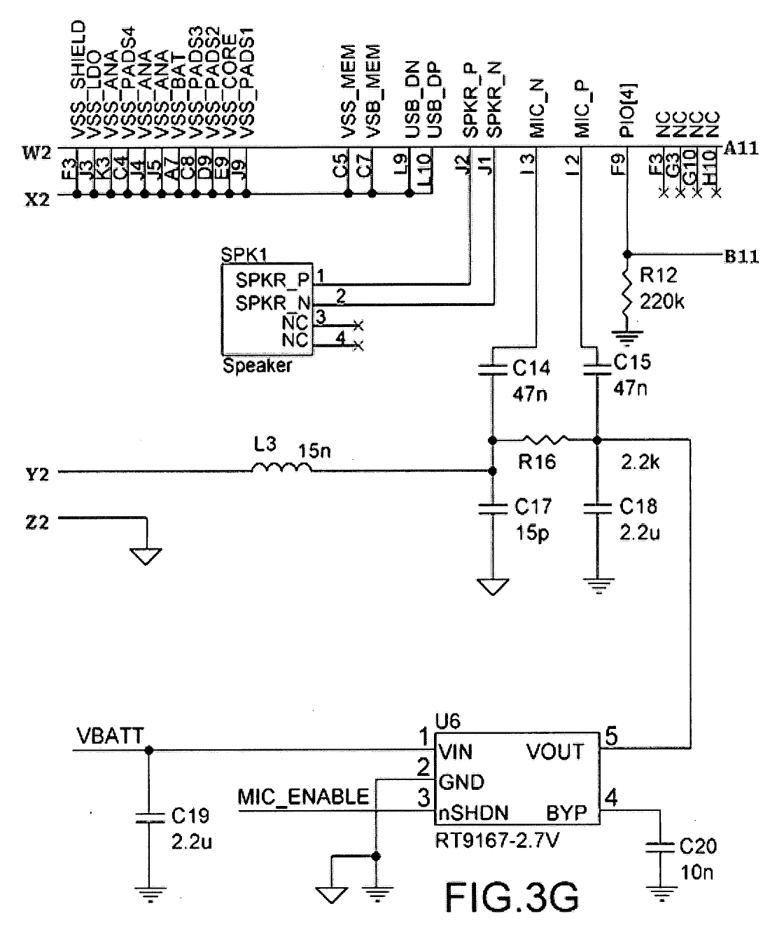

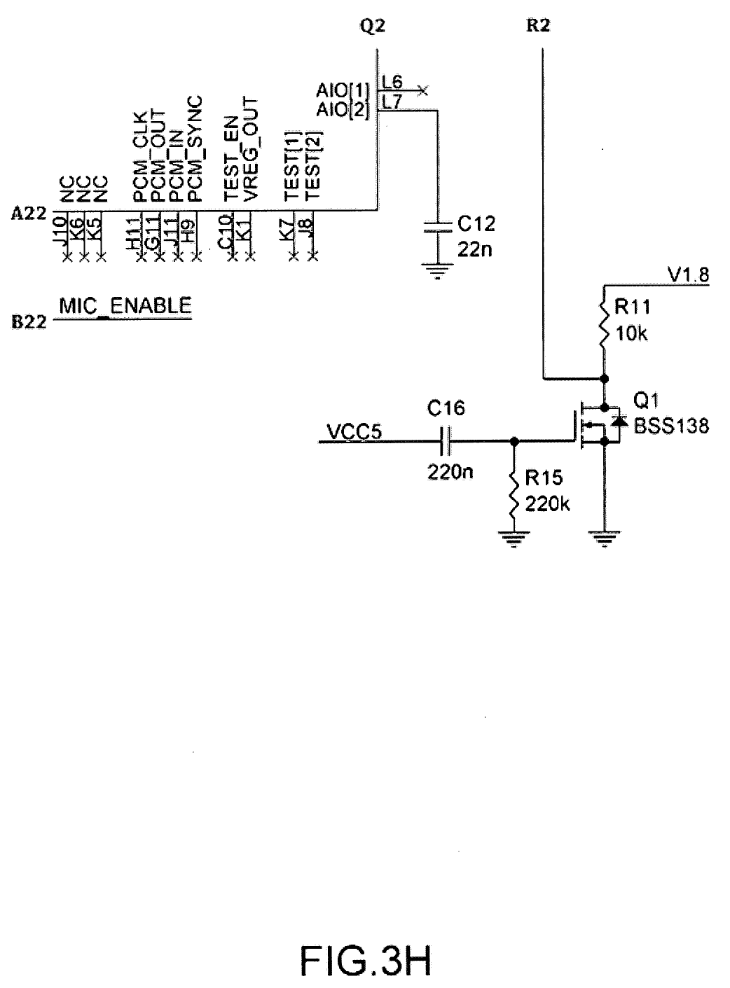

### LEGENDS

10 audio signal output module
20 audio signal input module
30 key-in module
40 Bluetooth module
50 antennae
60 power supply
110 user
120 Bluetooth earphone
130 audio gateway 1
140 audio gateway 2
150 communication started (on-going conversation 1)
160 audio gateway 2 alerts user via Bluetooth wireless connection that new audio signals are coming in.
170 communication established
180 communication started (communication held in waiting 1, communication effected 2)

What is claimed:

1. A multiple audio gateway Bluetooth earphone, comprising:
an audio signal input module, to receive audio signals;
an audio signal output module, to send out audio signals;
a Bluetooth module, to transmit and receive Bluetooth signals and to switch between a plurality of audio gateways a key-in module with buttons for users to press commands; and
a power supply, to provide required power;
wherein said audio signal input module serves as the audio signal source for said Bluetooth earphone, and said audio signal output module functions as receiver of audio signals from said audio signal input module via said Bluetooth module, that when said Bluetooth earphone is communicating via Bluetooth wireless connection with one of said audio gateways, another audio gateway may, via the existing or a newly established wireless connection, prompt another incoming call, and through the switching function built in the Bluetooth module, the earphone can detect the calling signals, by which to trigger a signal alerting the user that there is another call coming in, and the user may choose to answer or ignore the new call, with the on-going call being hung up or put in waiting, or to invite the new caller to join the on-going conversation to form a multi-party phone conference.

2. Said multiple audio gateway Bluetooth earphone as in claim 1, wherein said audio signal input module can receive any audio signals from computers, cell phones, or PDAs.

3. Said multiple audio gateway Bluetooth earphone as in claim 1, wherein said power supply can be a rechargeable battery or any other kind of battery.

4. Said multiple audio gateway Bluetooth earphone as in claim 1, wherein said Bluetooth earphone can be of any shape or design.

5. Said multiple audio gateway Bluetooth earphone as in claim 1, wherein the switching option of said audio gateways can be as many as said Bluetooth earphone can offer.
